(19) United States
(12) Patent Application Publication
(10) Pub. No.: US 2022/0212771 A1
(43) Pub. Date: Jul. 7, 2022

(54) Balloon

(71) Applicant: Iwaya Giken Inc., Sapporo-shi (JP)

(72) Inventor: Keisuke IWAYA, Sapporo-shi (JP)

(21) Appl. No.: 17/454,887

(22) Filed: Nov. 15, 2021

(30) Foreign Application Priority Data
Nov. 16, 2020 (JP) 2020-190553
Sep. 15, 2021 (JP) 2021-150497

(51) Int. Cl. B64B 1/40; F16B 2/00

(52) U.S. Cl. CPC B64B 1/40; F16B 2/00

(57) ABSTRACT

The present invention provides a means of easily attaching and detaching a member that reinforces an envelope of a balloon to and from the envelope. Balloon 1 according to an embodiment of the present invention comprises Inner Member 121 and Outer Member 123. Each of Inner Member 121 and Outer Member 123 is a disk-shaped member made of a plastic, a light metal, or other lightweight material. Inner Member 121 and Outer Member 123 are attached to Envelope 11 by tightening Bolts 125 and Nuts 126, with Envelope 11 therebetween. A donut-shaped Rubber Seal 122 is located on the surface of Inner Member 121 in contact with Envelope 11, and a donut-shaped Rubber Seal 124 is located on the surface of Outer Member 123 in contact with Envelope 11. Rubber Seal 122 and Rubber Seal 124 are pressed tightly against Envelope 11 as Bolts 125 and Nuts 126 are tightened, and Holes H2 provided in Envelope 11 to accommodate Bolts 125 are sealed.

### TECHNICAL FIELD

This invention relates to balloons.

### BACKGROUND ART

To improve a balloon's ability to fly, an envelope should be as lightweight as possible. In general, however, a light envelope has a low strength.

As a technique for reinforcing a strength of an envelope, for example, Patent Document 1 discloses a balloon with a structure such that a ring or disk-shaped rigid body is placed at the top of an envelope and the envelope and load tapes are attached to the rigid body.

According to the disclosure of Patent Document 1, the load concentrated at the zenith of the envelope is applied to the rigid body, which enables the balloon to carry heavier loads as compared to a balloon that lacks a rigid body arrangement.

### PRIOR ART DOCUMENT

### Patent Document

Patent Document 1: U.S. patent Ser. No. 10/293,913

### SUMMARY OF THE INVENTION

### Problem to be Solved by the Invention

By attaching to an envelope a member that has a greater strength than the envelope, as in the balloon disclosed in Patent Document 1, the envelope can be reinforced.

Heat welding or gluing is commonly used as a method of attaching to an envelope a member that has a greater strength than the envelope. For example, in the balloon disclosed in Patent Document 1, the envelope is heat-welded to a component placed at the zenith of the envelope.

A process of attaching a component to an envelope by heat welding or gluing is labor intensive. In addition, once a component is attached to an envelope by heat welding or gluing, the component cannot be easily removed from the envelope.

In view of the above-mentioned circumstances, an object of the present invention is to provide a means of easily attaching to and detaching from an envelope a component that reinforces the envelope of the balloon.

### Means for Solving the Problem

The present invention includes, as a first aspect, a balloon comprising: an inner member having a greater strength than an envelope, located inside the envelope, an outer member having a greater strength than the envelope, located outside the envelope, and a tightening member that tightens the inner member and the outer member with the envelope sandwiched therebetween.

According to the first aspect of the invention, the inner member and the outer member each has a greater strength than the envelope, so the envelope is reinforced by the inner member and the outer member. The inner member and the outer member can be easily attached to the envelope by tightening by use of the fastening member. Also, the inner member and the outer member attached to the envelope can be easily removed from the envelope by loosening the tightening member.

The present invention includes, as a second aspect, a balloon according to the first aspect, wherein at least a part of the inner member that receives a load from the envelope and a part of the outer member that receives a load from the envelope are made from at least one of a metal and a plastic.

According to the second aspect of the invention, the envelope is reinforced by the inner member and the outer member without significantly increasing an overall weight of the balloon.

The present invention includes, as a third aspect, a balloon according to the first aspect, wherein the inner member and the outer member have an opening and closing mechanism that moves between a closed state that hermetically seals an inside of the envelope and an open state that forms a gas flow path between the inside of the envelope and an outside of the envelope.

According to the third aspect of the invention, since the opening and closing mechanism is provided on the inner member and the outer member, the envelope is not damaged when the envelope is opened or closed.

The present invention includes, as a fourth aspect, a balloon according to the third aspect, comprising: a flow meter attached to the inner member or the outer member to measure a flow rate of a gas discharged from the inside of the envelope to the outside of the envelope when the opening and closing mechanism is in the open state.

According to the fourth aspect of the invention, an amount of the gas discharged from the envelope can be specified.

The present invention includes, as a fifth aspect, a balloon according to the first aspect, comprising an electronic device attached to the inner member or to the outer member.

According to the fifth aspect of the invention, it is easier to install and remove the electronic device than in a case that the electronic device is directly mounted to the envelope.

The present invention includes, as a sixth aspect, a balloon according to the first aspect, wherein at least one of the inner member and the outer member forms a housing space, and the balloon comprises an electronic device housed in the housing space.

According to the sixth aspect of the invention, it is easier to install and remove the electronic device than to mount it directly on the envelope. Further, according to the sixth aspect of the invention, the electronic device is protected from the outside by the inner member and the outer member.

The present invention includes, as a seventh aspect, a balloon according to the sixth aspect, wherein the housing space is watertight and sealed.

According to the seventh aspect of the invention, when the balloon lands on water, the electronic device is not inundated with the water.

The present invention includes, as an eighth aspect, a balloon according to the first aspect, wherein the inner member and the outer member are located at a zenith of the envelope.

According to the eighth aspect of the invention, a load concentrated at the zenith of the envelope is applied to the inner member and the outer member. As a result, the envelope according to the eighth aspect can withstand greater loads than an envelope of a conventional balloon.

The present invention includes, as a ninth aspect, a balloon according to the eighth aspect, comprising: one or more load tapes connected to at least one of the inner member and the outer member and partially attached to the envelope, wherein a strength each of the inner member and the outer member is greater than a strength of the one or more load tapes.

According to the ninth aspect of the invention, since most of a load is applied to the load tapes, a strength of which is greater than that of the envelope, a balloon with a greater carrying capacity can be attained.

### BRIEF EXPLANATION OF THE DRAWINGS

FIG. 1 shows an exterior view of a balloon according to an exemplary embodiment of the present invention.

FIGS. 2A to 2E show a rigid member according to the exemplary embodiment of the present invention.

FIGS. 3A to 3C show a balloon according to a modification of the present invention.

FIGS. 4A to 4F show a balloon according to a modification of the present invention.

FIGS. 5A and 5B show an operation of a rigid member according to a modification of the present invention.

FIGS. 6A and 6B shows an operation of a rigid member according to a modification of the present invention.

FIG. 7 shows a rigid member and a wireless communication device housed in the rigid member according to a modification of the present invention.

FIG. 8 shows a rigid member and a flow meter housed in the rigid member according to a modification of the present invention.

FIG. 9 shows a rigid member and a wireless communication device housed in the rigid member according to a modification of the present invention.

FIG. 10 shows an exterior view of a balloon according to a modification of the present invention.

FIG. 11 shows an exterior view of a balloon according to a modification of the present invention.

### MODES FOR CARRYING OUT THE INVENTION

### Exemplary Embodiment

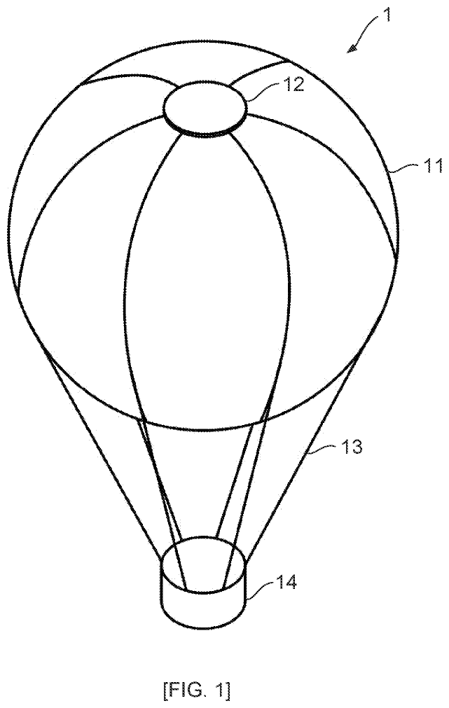

FIG. 1 shows an exterior view of Balloon 1 according to an exemplary embodiment of the present invention. Balloon 1 is a gas balloon. Balloon 1 has Envelope 11, Rigid Member 12 located at the zenith of Envelope 11, Suspension Ropes 13 attached to the outer surface of Envelope 11 and hanging downwards, and Housing 14 suspended by Suspension Ropes 13.

Envelope 11 is a spherical or droplet-shaped hollow bag that contains a lighter-than-air gas such as helium gas. Envelope 11, for example, is made of plastic films.

Rigid Member 12 is a member that reinforces Envelope 11. Thus, Rigid Member 12 has a greater strength than Envelope 11. In this embodiment, Rigid Member 12 is located at the zenith of Envelope 11 and serves to receive loads concentrated at the zenith.

Suspension Ropes 13 are ropes that connect Envelope 11 to Housing 14 and serve to transfer buoyancy generated in Envelope 11 to Housing 14.

Housing 14 is a cage or box-like component that holds cargo to be transported. Housing 14 may, for example, house members of crew. A load corresponding to a weight of Housing 14 and cargo contained in Housing 14 is applied to Envelope 11 via Suspension Ropes 13. Although the load applied to Envelope 11 is concentrated at the zenith, Rigid Member 12 bears the load, thus preventing Envelope 1I from becoming torn at the zenith. Accordingly, Balloon 1 has a greater carrying capacity as compared to conventional balloons that lack Rigid Member 12.

Rigid Member 12 has an inner member located inside Envelope 11, an outer member located outside Envelope 11, and a tightening member that is tightened to clamp Envelope 11 between the inner and outer members.

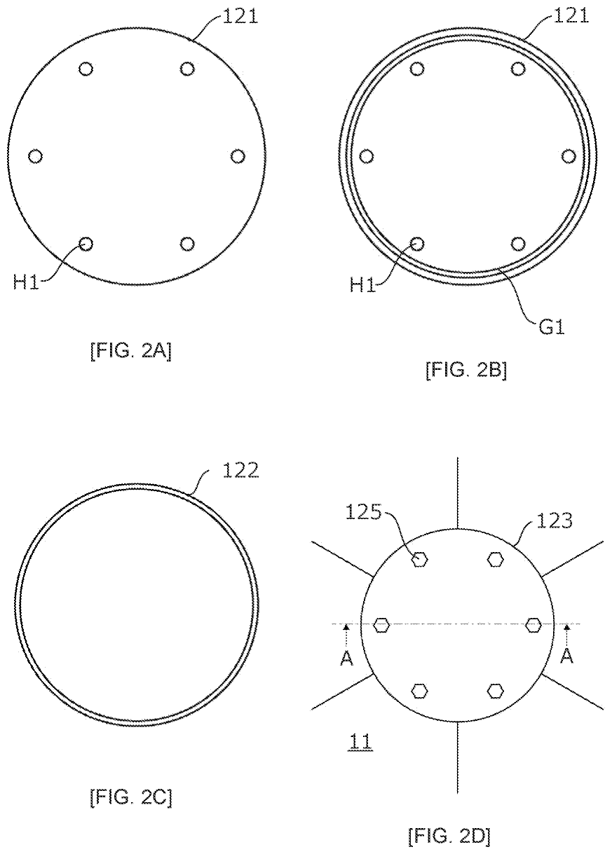

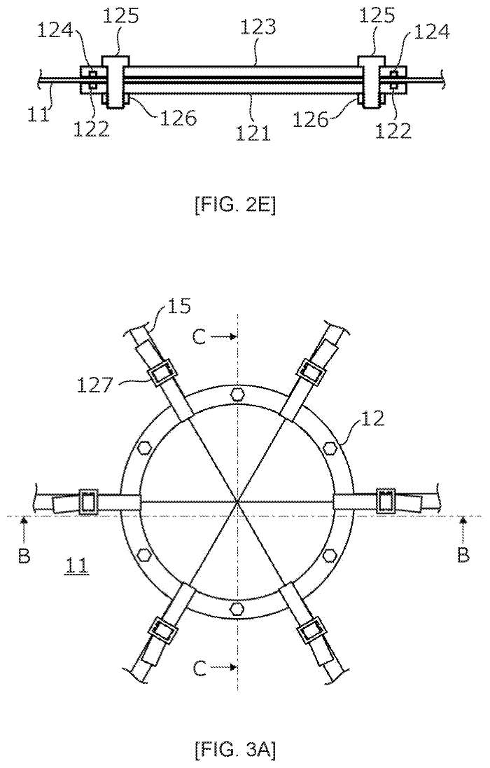

FIGS. 2A to 2E show a configuration of Rigid Member 12. Rigid Member 12 consists of Inner Member 121, Rubber Seal 122 which is a sealing member for Inner Member 121, Outer Member 123, Rubber Seal 124 which is a sealing member for Outer Member 123, and sets of Bolts 125 and Nuts 126 for tightening Inner Member 121 and Outer Member 123. The sets of Bolts 125 and Nuts 126 are an example of a tightening member.

Inner Member 121 and Outer Member 123 are of the same material and structure. Rubber Seal 122 and Rubber Seal 124 are of the same material and structure. Accordingly, while description is given below of the materials and structures of Inner Member 121 and Rubber Seal 122, description of the materials and structures of Outer Member 123 and Rubber Seal 124 is omitted.

FIG. 2A shows the front side of Inner Member 121, while FIG. 2B shows the back side of Inner Member 121. Inner Member 121 is disk-shaped as a whole, and is made of plastic. Inner Member 121 has Holes H1 into each of which Bolt 125 is inserted. On the back side of Inner Member 121, there is Groove G1 that extends around the entire circumference outside of Holes H1. Groove G1 is a groove provided for fitting Rubber Seal 122.

FIG. 2C shows Rubber Seal 122. Rubber Seal 124 is made of an elastic material such as rubber. Rubber Seal 122 is donut-shaped in plan view and rectangular as viewed in cross section. A width of Rubber Seal 122, i.e. a horizontal length of a cross section of Rubber Seal 122, is approximately the same as the width of Groove G1 of Inner Member 121. A height of Rubber Seal 122, i.e. a vertical length of a cross section of Rubber Seal 122, is greater than a depth of Groove G1. Therefore, when Rubber Seal 122 is fitted into Groove G1, a part of Rubber Seal 122 protrudes outside of Groove G1. The outwardly protruding portion of Rubber Seal 122 is pushed into Groove G1 upon tightening, and adheres to Envelope 11 under force to return to its original shape. As a result, gas that would otherwise leak from Holes H2 provided in Envelope 11 to accommodate Bolts 125 is sealed by Rubber Seal 122.

FIG. 2D shows the zenith of Envelope 11. Envelope 11 has Holes H2 (not shown in FIG. 2D) in its zenith for accommodating Bolts 125 at positions corresponding to Holes H1 of Inner Member 121.

Rigid Member 12 is attached to Envelope 11, for example, as follows. First, a user places Inner Member 121 with Rubber Seal 122 attached at a position where Holes H1 of Inner Member 121 and Holes H2 of Envelope 11 are connected, with the back side of Inner Member 121 facing the inner side of Envelope 11. The user also places Outer Member 123 with Rubber Seal 124 attached at a position where Holes H1 of Outer Member 123 and Holes H2 of Envelope 11 are connected, with the back side of Outer Member 123 facing the outer side of Envelope 11. In this state, the user inserts Bolts 125 coated with sealant into Holes H1 of Outer Member 123, Holes H2 of Envelope 11, and Holes H1 of Inner Member 121, which are connected, from the outside. Then, the user tightens Bolts 125 against Nuts 126, such that Nuts 126 tighten against Bolts 125 from the inside. The sealant applied to Bolts 125 serves to close a slight gap between Bolts 125 and Holes H1. When the user tightens Bolts 125 and Nuts 126, Inner Member 121 and Outer Member 123 sandwich Envelope 11, and Rigid Member 12 is attached to Envelope 11.

In the above explanation, it is assumed that Holes H2 are pre-punched in Envelope 11 to accommodate Bolts 125. However, Holes H2 may be punched during the installation of Rigid Member 12 to Envelope 11. In this case, with Envelope 11 placed against and sandwiched between Inner Member 121 and Outer Member 123, the user punches Holes H2 in portions of Envelope 11 that do not connect Holes H1 of Outer Member 123 with Holes H1 of Inner Member 121. The user then inserts Bolts 125 into Holes H1 of Outer Member 123 and Holes H1 of Inner Member 121, for connection.

FIG. 2E shows in cross section a view of the zenith portion of Balloon 1 at the single-pointed position in FIG. 2E in the direction of arrow A.

Rigid Member 12 can be easily attached to Envelope 11 by tightening Bolts 125 and Nuts 126. Rigid Member 12, and can be easily removed from Envelope 11 by loosening and removing Bolts 125 and Nuts 126. The type of fastening member is not limited to the combination of Bolts 125 and Nuts 126. For example, threaded holes may be provided in Inner Member 121 instead of Holes H2, and Bolts 125 may be screwed into the threaded holes.

### [Modifications]

The above-described Balloon 1 is of an exemplary embodiment of the present invention, and may be modified in various ways. Following are examples of modifications of the above-described embodiment. Two or more of the above-described embodiment and the following modifications may be combined.

(1) Balloon 1 is not limited to a gas balloon. For example, Balloon 1 may be a hot-air balloon. In that case, Envelope 11 accommodates a heated gas such as air that is continuously supplied from below instead of a lighter-than-air gas such as helium gas.

(2) The material of Envelope 11 is not limited to a plastic. For example, Envelope 11 may be made of a fabric or other material that is treated to be non-permeable by air.

(3) Inner Member 121 and Outer Member 123 may be made of a fiber reinforced plastic such as a carbon fiber reinforced plastic, fiberglass reinforced plastic, etc.

(4) Materials of Inner Member 121 and Outer Member 123 are not limited to plastic. For example, Inner Member 121 or Outer Member 123 may be made of metal, ceramic, wood, etc. However, from a standpoint of strength per unit weight and ease of processing, plastics or light metals are suitable for use as materials for Inner Member 121 and Outer Member 123.

(5) Inner Member 121 and Outer Member 123 may be made from multiple materials. For example, Inner Member 121 and Outer Member 123 may be made of a combination of plastic and metal. The entirety of Inner Member 121 or Outer Member 123 need not be highly rigid. It is sufficient if at least a part of Inner Member 121 and Outer Member 123 that receives load from Envelope 11 is made of a material that has a greater strength than Envelope 11, such as a metal or a rigid plastic.

(6) Shapes of Inner Member 121 and Outer Member 123 are not limited to a flat disk shape. For example, a shape of Inner Member 121 and Outer Member 123 may be a curved disk shape that fits the shape of Envelope 11. A shape of Inner Member 121 and Outer Member 123 may be different. For example, Inner Member 121 may be a flat disk shape while Outer Member 123 may be a non-flat shape, such as a conical shape, a hemispherical shape, or a shape obtained by cutting a sphere in a plane thinner than a hemisphere. It is desirable for Outer Member 123 to have a shape that in plan view rises toward the center, such as a conical shape, since such a shape reduces aerodynamic drag at the zenith of Envelope 11 when Balloon 1 rises.

Shapes of Inner Member 121 and Outer Member 123 in plan view are not limited to a circle. For example, shapes of Inner Member 121 and Outer Member 123 in plan view may be a polygonal shape. Shapes of Inner Member 121 and Outer Member 123 in plan view may have an open area such as a doughnut shape.

(7) If Balloon 1 is equipped with load tapes attached to Envelope 11, the load tapes should be connected to Rigid Member 12. In this case, a strength of Rigid Member 12 should be greater than that of the load tapes.

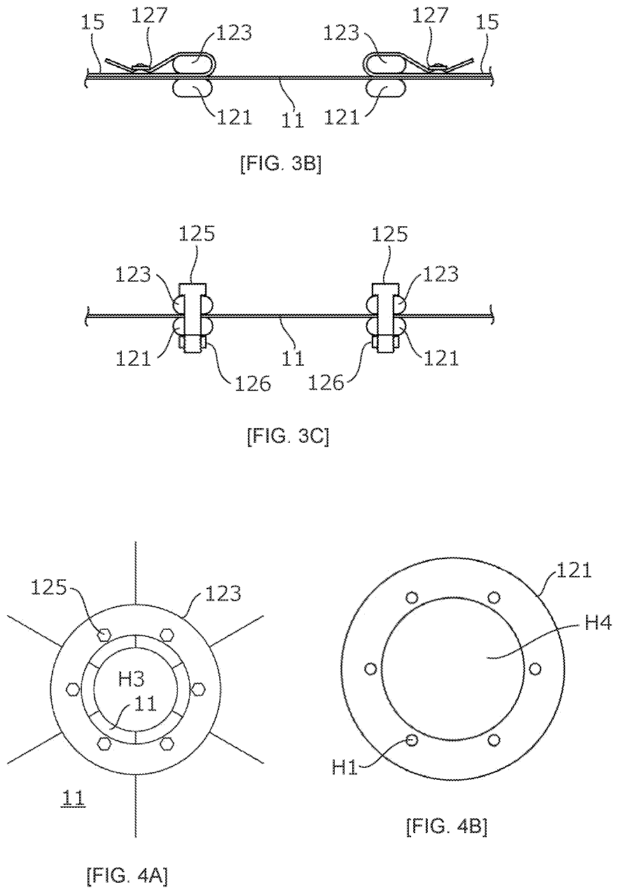

FIGS. 3A to 3C show the zenith portion of an example of Balloon 1 according to this modification. FIG. 3A shows the zenith portion of Envelope 11 viewed from the outside. FIG. 3B shows a cross section of the zenith portion of Balloon 1 at the single-pointed position in FIG. 3A in the direction of arrow B. FIG. 3C shows a cross section of the zenith portion of Balloon 1 at the single-pointed position in FIG. 3A in the direction of arrow C. In this modification, Load Tapes 15 are attached to the outside of Envelope 11. Suspension Ropes 13 are connected to Load Tapes 15, so that a load generated by Housing 14 and cargo in Housing 14 is not applied directly to Envelope 11, but rather is applied to Load Tapes 15.

In this modification, Inner Member 121 and Outer Member 123 are ring-shaped. Each of Load Tapes 15 is attached to the outer surface of Envelope 11 by, for example, adhesion, until close to the zenith of Envelope 11. The end of each of Load Tapes 15 after reaching close to the zenith of Envelope 11 is connected to Outer Member 123 by being passed through Length-adjustment Member 127 and is then folded upward to pass between Inner Member 121 and Outer Member 123 to cover the inner side of Outer Member 123, and is then again passed through Length-adjustment Member 127. In this state, Inner Member 121 and Outer Member 123 are tightened by Bolts 125 and Nuts 126, to secure Envelope 11 and Load Tape 15 there between.

(8) Inner Member 121 and Outer Member 123 may be configured with an opening and closing mechanism that switches between a closed state that hermetically seals the inside of Envelope 11 and an open state that forms a gas flow path between the inside of Envelope 11 and the outside of Envelope 11.

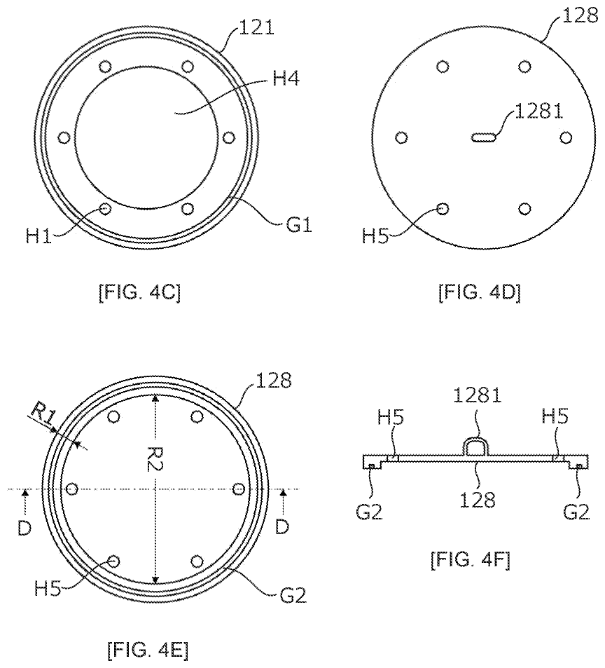

FIGS. 4A to 4F show the zenith portion of an example of Balloon 1 according to this modification. FIG. 4A shows the zenith portion of Envelope 11 viewed from the outside. In this modification, Envelope 11 has Hole H3 at the zenith. Hole H3 is normally sealed by Lid 128 of Rigid Member 12, but when a member of crew in Housing 14 pulls Control Cable 16 connected to Lid 128, Lid 128 is opened and gas in Envelope 11 is discharged from Envelope 11 through Hole H3.

According to this modification, Rigid Member 12 has Inner Member 121, Rubber Seal 122, Outer Member 123, Rubber Seal 124, Bolts 125 and Nuts 126. In addition, Rigid Member 12 has Lid 128, Rubber Seal 129 that acts as a sealing member for Lid 128, Nuts 130, and Springs 131.

According to this modification, Inner Member 121 and Outer Member 123 differ from those according to the embodiment in that their shapes in plan view are donut shaped, namely, with Hole H4 in the center of a disk shape. FIG. 4B shows the front side of Inner Member 121 according to this modification, and FIG. 4C shows the back side of Inner Member 121 according to this modification. The structure of Outer Member 123 is identical to that of Inner Member 121.

Bolts 125 according to this modification have a longer threaded section than those of Bolts 125 according to the embodiment.

A structure each of Rubber Seal 122 and Rubber Seal 124 according to this modification are the same as Rubber Seal 122 and Rubber Seal 124 according to the embodiment. A structure of Rubber Seal 129 is the same as that each of Rubber Seal 122 and Rubber Seal 124.

FIG. 4D shows the front side of Lid 128, and FIG. 4E shows the back side of Lid 128. FIG. 4F shows a cross section of the zenith portion of Balloon 1 at the single-pointed position in FIG. 4E in the direction of arrow D. Lid 128 is disk-shaped as a whole. Lid 128 has a U-shaped Hook 1281 in the center of its surface. One end of Control Cable 16 is connected to Hook 1281.

Lid 128 is divided into Outer Portion R1 of a predetermined width inward from the outer edge, and Inner Portion R2 inward from Outer Portion R1. Outer Portion R1 protrudes inward from Inner Portion R2. Outer Portion R1 has Groove G2 for fitting Rubber Seal 129. Inner Portion R2 has Holes H5 into which Bolts 125 are inserted. Outer Portion R1 protrudes inward from Inner Portion R2 to avoid collision between Lid 128 and Nuts 126 when Lid 128 is attached to Envelope 11 from inside Inner Member 121.

Springs 131 are, for example, metallic strip springs. Springs 131 are mounted to cover shafts of Bolts 125 inserted into Holes H5 of Lid 128. Springs 131 are fastened to Bolts 125 by Nuts 130 into which Bolts 125 are screwed. Springs 131 act to press Lid 128 against Inner Member 121 and cause Rubber Seal 129 to seal Envelope 11.

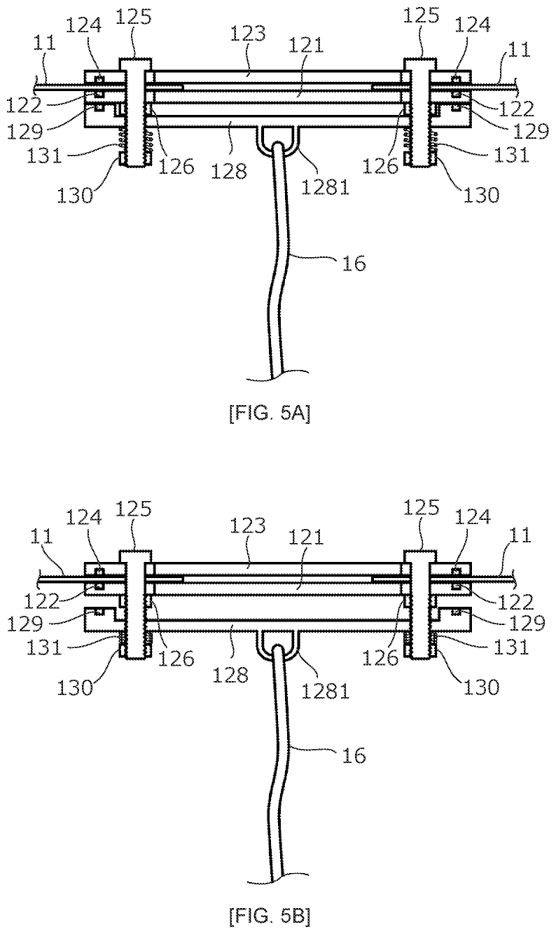

FIGS. 5A and 5B show an operation of Rigid Member 12 according to this modification. As long as Control Cable 16 connected to Hook 1281 is not pulled by the member of crew in Housing 14, Lid 128 is pressed against Inner Member 121 under elastic force of Springs 131, as shown in FIG. 5A, and gas contained in Envelope 11 is prevented from leaking out of Envelope 11. This state is referred to as a closed state. When the member of crew pulls Control Cable 16, Lid 128 separates from Inner Member 121 under the elastic force of Springs 131 and a gas flow path is created between Inner Member 121 and Lid 128, as shown in FIG. 5B. This state is referred to as an open state. When the member of crew stops pulling on Control Cable 16, Rigid Member 12 returns to the closed state.

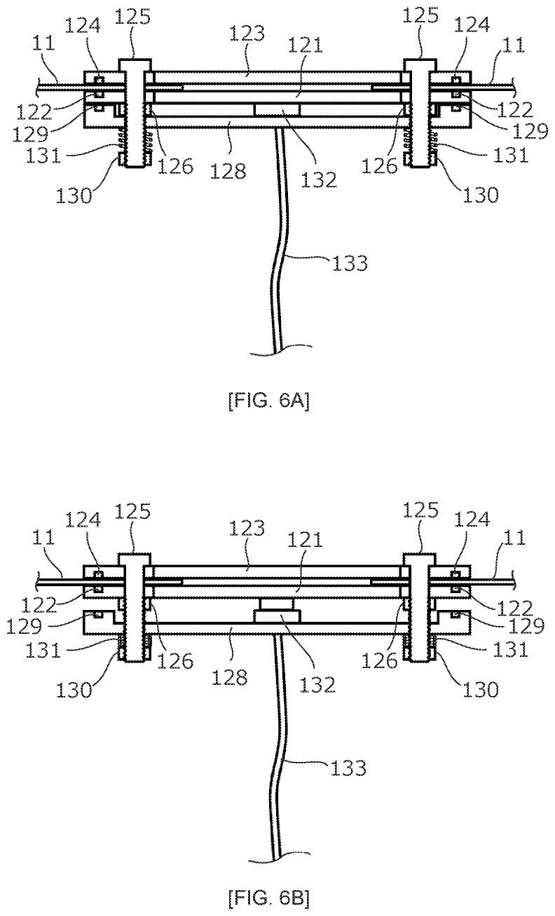

In the example described above, Lid 128 is opened and closed by pulling on Control Cable 16, but Lid 128 may be opened and closed by other methods. FIGS. 6A and 6B show an operation of Rigid Member 12 with a configuration in which Lid 128 is opened and closed by Hydraulic Actuator 132. A rod of Hydraulic Actuator 132 is normally retracted, as shown in FIG. 6A. When the member of crew pulls a lever in Housing 14, a pressure of hydraulic fluid pumped through Tube 133 pushes outward the rod of Hydraulic Actuator 132. As a result, a gap is created between Inner Member 121 and Lid 128, as shown in FIG. 6B. When the member of crew releases the lever, pressure of hydraulic fluid acting on the rod of Hydraulic Actuator 132 is released, and the elastic force of Springs 131 causes the rod to retract and return to the closed state as shown in FIG. 6A.

According to this modification, Inner Member 121 and Outer Member 123 serve as an exhaust mechanism, and thus there is no need to provide a separate exhaust mechanism.

(9) Balloon 1 may be equipped with an electronic device attached to Inner Member 121 or Outer Member 123. Types of electronic device that can be attached to Inner Member 121 or Outer Member 123 include, but are not limited to, a radio communication device that communicates wirelessly with a device on the ground, a control device that controls operations of other devices mounted to Balloon 1, a measuring device, a photographic device, a light emitting device, a sound emitting device, and a radio wave generator that emits radio waves to notify a current position of Balloon 1.

Types of measuring device that can be attached to Inner Member 121 or Outer Member 123 include, but are not limited to, an anemometer, thermometer, hygrometer, UV meter, radiation meter, GNSS (Global Navigation Satellite System) positioning device, etc.

Methods of attaching the electronic device to Inner Member 121 or Outer Member 123 include, but are not limited to, tightening with bolts and nuts or screws, adhering with adhesives or double-sided tape, etc.

In this modification, an electronic device that is usually placed in a housing of a conventional balloon is attached to Rigid Member 12. As a result, a load pulling Envelope 11 downward is reduced by a weight of the electronic device.

If the electronic device is directly attached to Envelope 11, a strength of Envelope 11 may not be able to withstand the weight of the electronic device, or a protruding part of the electronic device may come into contact with and damage Envelope 11. According to this modification, such problems do not occur because the electronic device is attached to Inner Member 121 or Outer Member 123, which are made of a material having a greater strength than Envelope 11.

Also, for certain types of electronic device, it is preferable to place them at the zenith of Envelope 11 rather than in Housing 14.

In general, it is desirable for a measurement to be performed by a measuring device under a constant measurement environment so as to obtain reliable comparative measurement results. The environment inside the housing varies depending on its size and a number of members of crew and devices housed therein. In contrast, the environment at the zenith of the envelope does not change significantly between balloons. Therefore, according to this modification in which the measuring device is placed at the zenith of the envelope, it is easy to compare results of measurements performed using different balloons.

If a light emitting device, a sound emitting device, a radio wave generating device, etc. is attached to Rigid Member 12 at the zenith of Envelope 11, when Balloon 1 returns to the ground or to water, there is less chance of the device being covered by Envelope 11, and signals emitted by the device can be readily detected.

The electronic device attached to Inner Member 121 or Outer Member 123 may be mounted outside of Inner Member 121 or Outer Member 123, and thus exposed to the outside. Alternatively, the electronic device attached to Inner Member 121 or Outer Member 123 may be accommodated in a housing space formed by Inner Member 121 and Outer Member 123. In this case, the electronic device is protected from the outside. When Inner Member 121 and Outer Member 123 form a housing space, the housing space may be watertight and sealed. In this case, when Balloon 1 lands on water, the electronic device will not be inundated with the water.

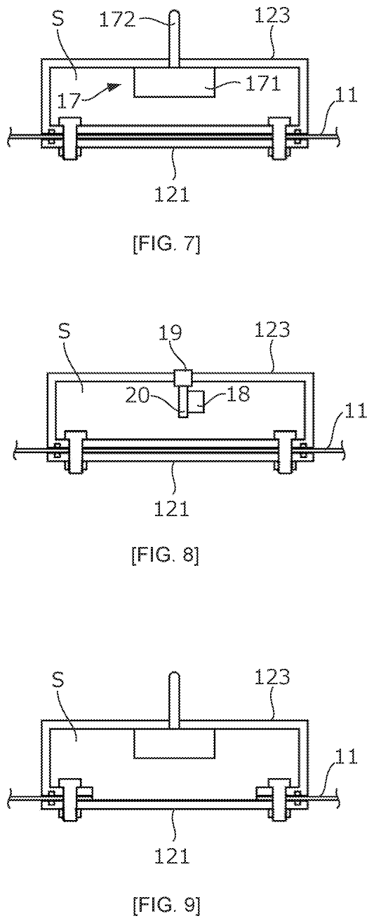

FIG. 7 shows an example where Rigid Member 12 forms a housing space. In Rigid Member 12 shown in FIG. 7, Outer Member 123 is box-shaped, and Housing Space S is formed inside it. In FIG. 7, Main Body 171 of Wireless Communication Device 17 is arranged as an example of an electronic device to be housed in Housing Space S. Antenna 172 of Wireless Communication Device 17 is positioned to protrude outside Outer Member 123 to avoid shielding of radio waves by Rigid Member 12. A gap between a hole in Outer Member 123 for accommodating Antenna 172 and Antenna 172 may be sealed by a sealing member.

FIG. 8 shows an example where Flow Meter 18 is placed in Housing Space S. In this example, Outer Member 123 has a hole for exhausting air, and Shut-off Valve 19 is arranged to seal the hole. In Housing Space S, there are located Tube 20, which forms a flow path for gas discharged from inside Envelope 11 to outside Envelope 11 when Shut-off Valve 19 is opened, and Flow Meter 18, which measures a flow rate ofgas flowing inside Tube 20. Shut-off Valve 19 may be a solenoid valve that opens and closes in response to a radio signal transmitted from a device in Housing 14. According to Balloon 1, which is equipped with Flow Meter 18 as shown in FIG. 8, an amount of gas discharged from Envelope 1 can be specified.

A location where Housing Space S is formed is not limited to inside Outer Member 123, but Housing Space S may be formed inside Inner Member 121.

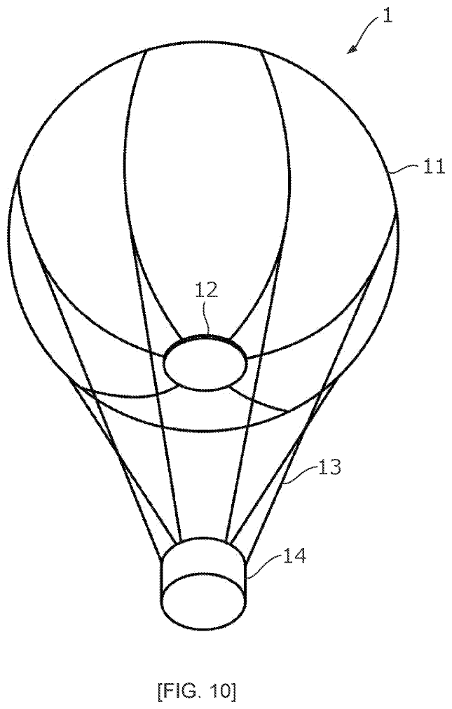

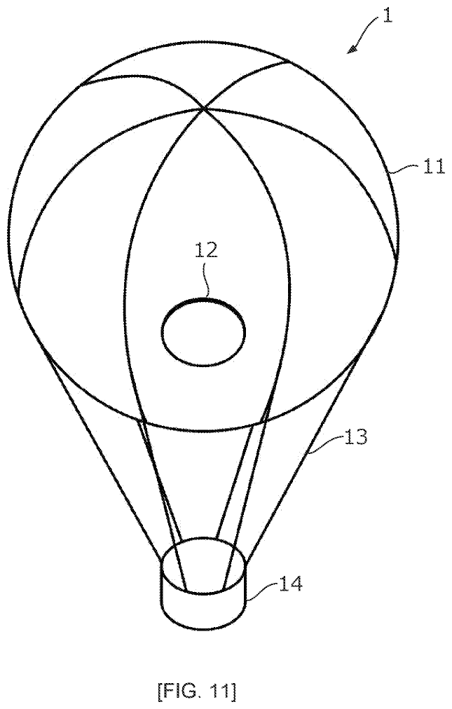

Housing Space S may be formed by Inner Member 121 and Outer Member 123. For example, as shown in FIG. 9, Outer Member 123 may be configured as a box shape with an opening in one of its six sides that is in contact with Envelope 11, and Inner Member 121 may serve as a lid to close the opening of Outer Member 123. In this case, the portion of Envelope 11 corresponding to the opening of Outer Member 123 is hollowed out. According to this modification, an electronic device can be easily placed in and removed from Housing Space S.

Inner Member 121 may be configured as a box shape with an opening in the six sides that is in contact with Envelope 11, and Outer Member 123 may serve as a lid to close the opening of Inner Member 121.

(10) A location of Rigid Member 12 is not limited to the zenith of Envelope 11. FIG. 10 shows Balloon 1 with Rigid Member 12 located at the bottom of Envelope 11.

For example, when Rigid Member 12 has the exhaust mechanism of modification (8), Control Cable 16, one end of which is attached to Hook 1281, hangs down under gravity toward Housing 14, making it easier to handle Control Cable 16 than when Rigid Member 12 is located at the zenith.

Rigid Member 12 according to modification (9) has an electronic device attached thereto or housed therein. When a weight of the electronic device is heavy, if Rigid Member 12 is placed at the bottom of Envelope 11, a center of gravity of Balloon 1 becomes lower than if the electronic device is placed at the zenith, and a posture of Balloon 1 is thus more stable.

FIG. 11 shows Balloon 1 with Rigid Member 12 located at a lateral part of Envelope 11. For example, a measuring device that measures a force striking Envelope 11 from the side should be located at a lateral part of Envelope 11. Also, a communication device that communicates with devices on the ground by electromagnetic waves may obtain high antenna gain by being equipped with a horizontally extending antenna. In such cases, the electronic device should be mounted to or housed in Rigid Member 12, which is located at the lateral part of Envelope 11.

(11) The structures and shapes of Rigid Member 12 shown in the above description of embodiment and modifications are examples and may be changed in various ways.

### DESCRIPTION OF REFERENCE NUMERALS

1: Balloon
11: Envelope
12: Rigid Member
13: Suspension Rope
14: Housing
15: Load Tape
16: Control Cable
17: Wireless Communication Device
18: Flow Meter
19: Shut-off Valve
20: Tube
121: Inner Member
122: Rubber Seal
123: Outer Member
124: Rubber Seal
125: Bolt
126: Nut
127: Length-adjustment Member
128: Lid
129: Rubber Seal
130: Nut
131: Spring
132: Hydraulic Actuator
133: Tube
171: Main Body
172: Antenna
1281: Hook

1. A balloon comprising:
an inner member having a greater strength than an envelope, located inside the envelope,
an outer member having a greater strength than the envelope, located outside the envelope, and
a tightening member that tightens the inner member and the outer member with the envelope sandwiched therebetween.

2. A balloon according to claim 1, wherein
at least a part of the inner member that receives a load from the envelope and a part of the outer member that receives a load from the envelope are made from at least one of a metal and a plastic.

3. A balloon according to claim 1, wherein
the inner member and the outer member have an opening and closing mechanism that moves between a closed state that hermetically seals an inside of the envelope and an open state that forms a gas flow path between the inside of the envelope and an outside of the envelope.

4. A balloon according to claim 3, comprising:
a flow meter attached to the inner member or the outer member to measure a flow rate of a gas discharged from the inside of the envelope to the outside of the envelope when the opening and closing mechanism is in the open state.

5. A balloon according to claim 1, comprising:
an electronic device attached to the inner member or to the outer member.

6. A balloon according to claim 1, wherein
at least one of the inner member and the outer member forms a housing space, and
the balloon comprises an electronic device housed in the housing space.

7. A balloon according to claim 6, wherein
the housing space is watertight and sealed.

8. A balloon according to claim 1, wherein
the inner member and the outer member are located at a zenith of the envelope.

9. A balloon according to claim 8, comprising:
one or more load tapes connected to at least one of the inner member and the outer member and partially attached to the envelope,
wherein
a strength each of the inner member and the outer member is greater than a strength of the one or more load tapes.
